(19) United States
(12) Patent Application Publication
(10) Pub. No.: US 2007/0276769 A1
(43) Pub. Date: Nov. 29, 2007

(54) Automatic Bartering Proposal for Content Exchange

(75) Inventors: Arjan Claassen, Eindhoven (NL); Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,863

(22) PCT Filed: Apr. 11, 2005
(86) PCT No.: PCT/IB05/51174

§ 371 Date: Oct. 12, 2006

(30) Foreign Application Priority Data
Apr. 16, 2004 (EP) 04101570.2

(51) Int. Cl. G06Q 99/00

(52) U.S. Cl. 705/80

(57) ABSTRACT

The present invention relates to a method for automatic bartering for items, between at least a first and a second bartering party, at a programmable device. The process of bartering is enhanced by letting the programmable device handle at least a part of the bartering process that helps in reducing the amount of items that the user has to consider, and in selecting the most interesting items available from the other user. The method includes exchange of preference data between the parties, computing and exchanging offers, and processing the offers. The processing finally results in mutual offer acceptances. The present invention also relates to a programmable device, and a system for automatic bartering for items.

### TECHNICAL FIELD OF THE INVENTION

The present invention relates to a method, a programmable device and a system for bartering for items between two and more parties.

### BACKGROUND OF THE INVENTION

Bartering for items is a practice, which dates back to a time very long ago. Today we learn it for example at schoolyards, where we barter for stickers or football cards with our friends.

US 2003/0001882 A1 describes an entertainment machine, which can be used for swapping items between a pair of such machines. The machines communicate with each other over a short-range wireless communication facility. The items, which a first user wants to swap, are shown in a selected articles window at a first device, and the items, which a second user is offering the first user, are shown in an offered articles window, also at said first device. If a user agrees to exchange the articles, which are shown in the selected articles window and the offered articles window, respectively, he presses an acceptance button on his device. After both users have agreed to exchange items, the items are exchanged between the machines.

Problems arise when the users have collected a lot of items, which they want to exchange. Storage in portable consumer electronic products ranges today from 1 Gigabyte to 60 Gigabytes, and will probably continue to grow up to 300 Gigabytes. This means that consumers will be able to store their entire music collection (60 Gigabytes/3 Megabytes per song=20,000 songs) on one device. Such an amount of data would take a substantial time to handle at a bartering process or transfer between two devices. For example 10,000 items, which are described in 500 Bytes to 2 Kilobytes each, equals 5-20 Megabytes of descriptive information. A transferring rate of 0.5 Megabyte per second, would give 10-40 seconds just to download the item descriptions. Moreover, the users will find it a hassle to browse 10,000 items in order to construct a set of items that they want to trade.

### SUMMARY OF THE INVENTION

It is an object of the present invention to eliminate or at least alleviate the described problems related to automatic bartering, when it involves a large amount of bartering items. This object is achieved by a method and a system arranged in accordance with the appended claims 1, 11 and 23. Preferred embodiments are defined in the dependent claims.

The invention is based on an insight that by designing a suitable bartering algorithm for a bartering device in a bartering system, it is possible to provide a device which can create and handle bartering offers, containing a substantial number of bartering items, such that an accepted offer would mean a high gain for the receiving party, at the same time as the loss is minimal for the offering party.

As used herein the term “bartering” refers to a process, in which two or more parties exchange offers with each others. Each party can then choose to accept, modify or decline their respective received offers. The actual bartering process reaches an end when all concerned parties have accepted their respective offers, and a new process of implementing what has been agreed upon is initiated. It is also possible to start the exchange of items before the bartering process is finished.

Further, the term “items” refers to objects which at least two parties are interested in collecting and swapping with each other. These objects can be represented by data or metadata which describes the items, and which typically occupies substantially less memory, compared to the items they are representing. An item is for instance an electronic representation of a song, a photo, a football playing card, a game, an image, a tune, a film, etc. Data representing a song typically contains the title of the song, the name of the artist, the name of the album and possibly an image of the album cover. The metadata is always stored on and sent between the devices, whereas the items can be stored either on the device, or for example on the Internet.

Additionally, the term “bartering party” refers to an individual or a machine, capable of making decisions regarding whether an item is desirable to the party or not. The bartering party is also capable of valuing the items, at least in relation to other items.

When the bartering party is represented by an individual, the term “user” is alternatively used.

Finally, the term “bartering device” refers to a programmable device used by said bartering party to manage his/its part of the bartering process. However, said bartering items do not need to be stored on said bartering device, the device just needs to have knowledge about which items that are available to a certain bartering party. The items, which are accessible to one bartering party can be divided into two groups of items, one group in which the items are available for bartering, and another in which they are not.

Thus, according to a first aspect thereof, the present invention provides a method for automatic bartering for items, between at least a first and a second bartering party, at a programmable device. As used herein there are at least two parties involved in a bartering process, and each party is in possession of assets or items, which are available for bartering. Moreover, at least the first party has a programmable device, which is arranged according to the invention. Before a first offer can be generated by said device, it has to be provided with two sets of preference data, one for each bartering party. As used herein the term “preference data” refers to a set of data, which specifies how much a certain bartering party values certain items, possibly in relation to other items. Said device must also be informed of which items, related to said device, that are available for bartering. Provided this, said first device is able to compute an offer, which e.g. has a maximal value to the receiving second party and a minimal value to the offering first party, using a suitably designed algorithm. The computed offer is presented to the second bartering party, and in return an offer from the second bartering party is received by the first bartering party. Alternatively, said computed offer can be sent to said second bartering party in response to a previously received offer from said second party. The received offer from the second bartering party is processed by said device, and thereafter presented to said first bartering party. If both parties agree on their respective received offers, acceptance data is exchanged between the bartering parties, which ends the bartering process.

According to a second aspect thereof, the present invention provides a programmable device, intended to be used in a bartering system for automatic bartering for items. Said device comprises asset data, which as used herein is a term that refers to a list containing the items, that are accessible to said first bartering party, and bartering data, which as used herein is a term that refers to a list containing the items, that a first bartering party considers as available for bartering. Said device further comprises means, which are arranged to create and store a first set of preference data related to said first bartering party, and additionally means arranged to receive and store a second set of preference data, related to said second bartering party. Further, said device comprises means arranged to compute a first offer based at least on said first and second set of preference data, as well as said bartering data. There are also means arranged to send said first offer to said second bartering party, means arranged to receive and store an offer received from said second bartering party and means arranged to process said received second offer. Finally there are means arranged to create and send an offer accept to said second bartering party, and means arranged to receive an offer accept from said second bartering party.

According to a third aspect thereof, the present invention provides a system for automatic bartering for items between at least a first and a second bartering party. The bartering system comprises a first bartering device, which is arranged as described in relation to said second aspect of the invention, and a second bartering device, which is arranged to communicate with said first bartering device. That is, said second device is arranged to send a first set of preference data and an offer to said first bartering device, to receive an offer and later an offer accept from said first device and finally to send an offer accept to said second device.

As evident from above, one problem related to manual managing of vast amounts of data or items, is that it is difficult to create an overview of the content. This overview is necessary in order to know which offers are the most rewarding. Another problem is that a manual computation of how the value changes, according to the valuation of the two parties when different items are added or removed from an offer, is complex. Especially if also bonus values, such as a complete series of football player cards, are considered.

A first advantage of the three above aspects is that they facilitate a more rational way of managing substantial amounts of data or items. Manual administration of a collection containing for example 10,000 items, can be a cumbersome process that is streamlined using the invention.

A second advantage is that an offer computing algorithm is faster than manual administration. Therefore, it is possible to compare the outcome of many different offers in order to find the most optimal one. In a collection containing a vast number of items, a method, system or device according to the invention is able to fast sort out the most optimum offer, considering the preferences of both bartering parties, respectively.

A third advantage is that the whole list of all items available for bartering does not need to be transferred, but rather a smaller list containing the offered items.

The means for automatic valuation, as defined in claim 12, has the advantage that the first bartering party does not need to value all of the items. When the party has valued an initial number of them, and/or input some valuation principles to the device, the valuation of a selected number of items or all remaining items can be left to the device. This saves the first bartering party a lot of time consuming and tedious work, especially when the bartering party is an individual.

Arranging the processing means as defined in claim 13 has the advantage that the device can refuse items in an offer and later receive an altered offer, which fully or partly replaces the first offer.

Arranging the processing means as defined in claim 14, has the advantage that the user does not have to spend time calculating the value of a received offer manually, but is presented with the information automatically.

Arranging the processing means as defined in claim 15, has the advantage of enabling for the device to generate an altered offer, if parts of the previously computed offer was rejected, such that the bartering process can continue.

Arranging the processing means as defined in claim 16, has the advantage of enabling for the user to inspect and adjust a computed offer before it is sent to the second device. Thus, the user is in full control of the bartering process.

Arranging the processing means as defined in claim 17, has the advantage of informing the user of how an alteration of the offer affects the values of said offer. This is to facilitate for the user to make his decisions during the offer adjustment process. A manual calculation of these values might be a complex matter, especially if the offer contains many items and if bonus values for e.g. completeness of a series is used.

Arranging the processing means as defined in claim 18, has the advantage of making it easier for said first bartering party to decide how to handle a received offer.

Arranging the processing means for an iterative process, as defined in claim 19, has the advantage of being better adapted to certain generation algorithms.

Means arranged according to DRM, Digital Rights Management, as defined in claim 20, has the advantage of providing protection of the rights belonging to the provider of the items. It further facilitates the exchange of items between said first and second bartering parties.

Connecting the device to a wireless network, as defined in claim 21, has the advantage of allowing the user to move freely with his device and also allowing him to make contact with other devices within range.

Means arranged for handling and storing said items with said device, as defined in claim 22, has the advantage of allowing the user to use the same device for bartering and for transferring the items, which said bartering parties have agreed to exchange.

Some advantages, which are obtained by embodiments of said first device, have been described above. Similar advantages can also be achieved by corresponding embodiments of said bartering method and said bartering system, as defined in the dependent claims related to the system and the method, respectively.

Further, advantageously, if both said first and said second device are devices according to the invention, it is easy to include extra features which are supported by both devices.

Advantageously, when both said first and said second device are included in the same physical unit, as defined in claim 25, two parties are able to barter for information, even if only one of the parties has access to his device. This is typically implemented by the use of different user set ups. As there is no transaction of data between different units, the bartering process will also be faster.

The basic idea behind the invention is that, given some essential information, a computing algorithm can automatically create an offer, which generates a high gain for the receiving party at the same time as the loss is minimal for the transmitting party. As the computation is performed by some sort of computational means, the algorithm can take into consideration several more parameters, compared to if the process was to be handled manually within a given time.

Once a deal is agreed upon, typically the items and/or ownership and keys of the agreed items are exchanged between said first and second bartering parties. In addition, exchange of items can occur in an encrypted fashion while the bartering is ongoing. Once the bartering is complete, data exchange is completed and keys are exchanged, such that the closing of the transaction is faster. Items that have a high likelihood of being part of the final exchange are typically copied first. The likelihood can be computed based on the preference data from said first and second bartering parties. An item, which the offer receiving party values high, and the offering party low, will most likely be exchanged.

These and other aspects of the invention will be apparent from and elucidated with reference to the embodiment described hereinafter.

### BRIEF DESCRIPTION OF THE DRAWING

FIG. 1 schematically shows an embodiment of the present invention.

### DETAILED DESCRIPTION OF PREFERRED EMBODIMENTS

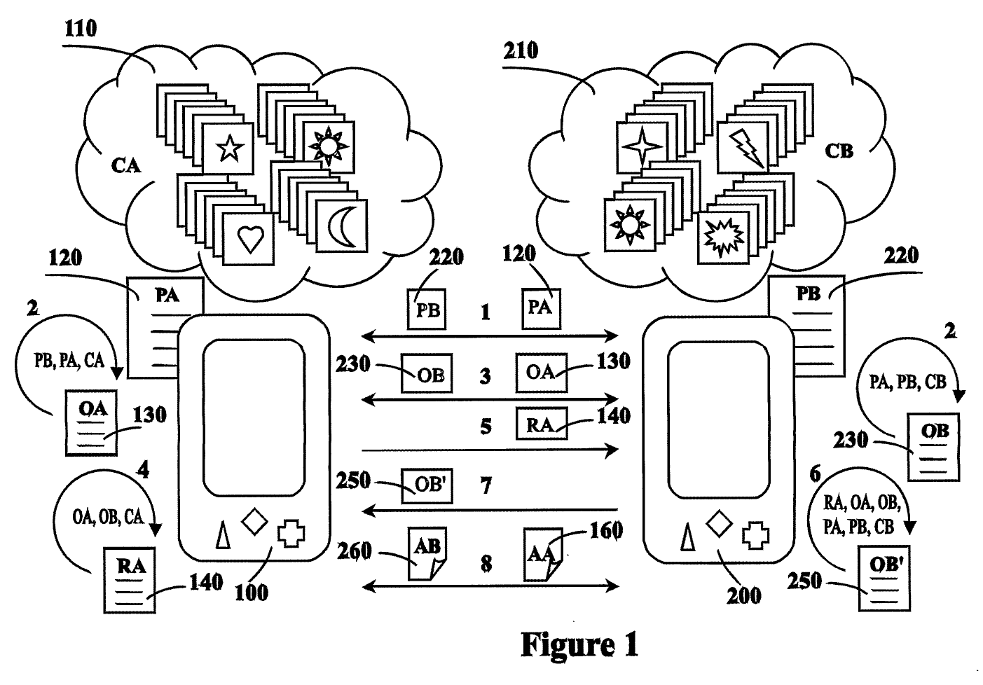

In one embodiment of the automatic bartering concept, John meets Rob on the schoolyard. Where in the past they would trade and barter stickers or football cards, now they can trade and barter electronic content or items using their portable devices. This bartering process will now be described with reference to FIG. 1. Both parties, John and Rob, are each in possession of a respective set of electronic items 110 and 210, and a programmable device 100 and 200, respectively. In this example the items comprises songs and albums by different artists. These items are stored on the devices, respectively. As a preparation for the bartering process, each user has provided his device with input data, rating each item according to his opinion. The items, which is most important to him, is given the value 10, and the items, which he is not at all interested in, is given the value 1. This is done for both songs, artists and albums, separately. Further, each device 100, 200 is arranged such, that if the user leaves some of the items unranked, the device will automatically rank or value the unranked objects for him. This automatic valuation is based on information related to previously valued items, in combination with valuation rules. A rule can, for example, state that if the user has indicated that he is collecting all the albums of a certain artist, albums and songs relating to this artist are automatically given a high value. Or, if an item would make a collection incomplete, the value of this item is increased. This data is stored in the form of preference data 120 and 220, respectively.

When John and Rob meet, their devices make contact by a wireless connection, such as a Bluetooth connection combined with a service framework of the type UPnP. When the connection between the devices has been established, the bartering process is initiated by the exchange 1 of preference data 120 and 220. John's device, herein called the first device 100, computes a first offer 130 based on the received preference data 220, the stored preference data 120 and the items available for bartering 110 at said first device 100. Rob's device, herein called the second device 200, computes a second offer 230 based on the received preference data 120, the stored preference data 220 and the items available for bartering 210 at said second device 200. The purpose of the computation is to find an offer, in which the items have a maximum value for the receiver and a minimum value for the sender of the offer. Hill Climbing is an optimization algorithm, which is well known in the art and suited for offer computation. There are other optimization functions, known in the art, like taboo search and simulated annealing, which can be used in a similar fashion.

The computed offers 130 and 230 are exchanged 2 between the first and second devices 100 and 200. In an alternative embodiment the user has a chance to modify the offer before it is sent. The received offers are processed by the devices 100 and 200, respectively, before they are presented to their respective users. This processing can involve rejecting all items in the received offer, which the user already possesses or which he has instructed the device that he does not desire. These instructions can be input data representing each item or group of items, which are of no interest to said second bartering party, or the instructions can be regulations sating how to determine whether an item is desirable to the bartering party or not. In this example only the first device 100 rejects any items, but said second device can also reject items, which were offered by said first device. Data 140 representing the rejected items are returned to the second device 200, which initially provided the offer 230. Based on the received rejected items 140, the previously calculated offer 230, the items available for bartering 210, the received set of preference data 110 and the stored sets of preference data 210, the second device 200 computes a replacing offer 250. The replacing offer 250 is sent to the first device 100, which previously rejected data representing one or several items 140.

In an alternative embodiment of the invention the receiving device 100 processes the received replacing offer 250, and if any undesired items are found, these too are rejected and sent to the second device 200. Upon which, a replacing offer is computed by the second device 200 and sent to the first device 100, in the same way as described above.

In an alternative embodiment of the invention the processing of the received offer further comprises calculating the value of the received offer, based on the items available at said device or preference data 120 and 220 from both said first and said second device 100 and 200, before said received offer and calculated values are presented for the user. When the user is presented with an offer he will always perform an individual, subjective valuation, but can be aided in this by the device with some objective valuations. For example, a certain song can be a “must have now” for a user, in which case he is prepared to ignore the objective valuation by the system. Still, the user then does this knowingly and is not unpleasantly surprised later.

In a further alternative embodiment of the invention the processing of the received offer further includes computing and presenting a suggestion of how to alter the received offer for the user. This computation is preformed in a way, which is similar to the computation of the first offer, but the computation of the suggestion is further based on both said current calculated offer and said current received offer and any rejected items.

If the user agrees with the offer that his device presents to him, he presses an acceptance button and an acceptance message is sent to the other device. Once both devices have received an acceptance message, the bartering process is completed.

In yet an alternative embodiment, the items in an offer is sent one by one from said first device to said second device. After the first device has sent a first offer, it waits until it has either received an acceptance or rejection of that offer, before another offer is sent. As soon as the first device gets a message that an item has been accepted by said second device, the first device starts to transmit the accepted item. If the first device gets a message that an item has been rejected by said second device, a new item is immediately offered by said second device.

Consequently, as described above, the present invention presents automatic bartering for items, between at least a first and a second bartering party, at a programmable device. The process of bartering is enhanced by letting the programmable device handle at least a part of the bartering process that helps in reducing the amount of items that the user has to consider, and in selecting the most interesting items available from the other user. It is to be noted, that for the purposes of this application, and in particular with regard to the appended claims, the word “comprising” does not exclude other elements or steps, that the word “a” or “an”, does not exclude a plurality, that a single processor or unit may perform the functions of several means, and that at least some of the means can be implemented in either hardware or software, which per se will be apparent to a person skilled in the art.

1-31. (canceled)

32. A method for automatic bartering for items, between at least a first and a second bartering party, at a programmable device (100), comprising the steps of:
creating a first set of preference data (120), that values items in accordance with input data originating from said first bartering party;
receiving (1) a second set of preference data (220), that values items in accordance with input data originating from said second bartering party;
computing (2) a first offer (130) based at least on said first and second sets of preference data and on items (110) available to said first party for bartering at said device;
presenting (3) said first offer to said second bartering party;
receiving (3) data representing a second offer (230) related to said second bartering party;
processing (4) said received offer by comparing offered items, contained in said received offer, at least to items accessible to said first bartering party (110), to said offer (120) computed by said first device (100) or to data originating from said first bartering party, stating which items that are to be rejected;
rejecting (5) one or several of said offered items;
receiving (7) a replacing offer (250) related to said second bartering party;
presenting (8) an offer accept (160) to said second bartering party; and
receiving (8) an offer accept (260) originating from said second bartering party.

33. A method according to claim 32, further comprising a step of automatically valuing an unranked item or group of items based at least on items (110) available to said first bartering party and/or based on preference data (120) of previously valued items or group of items.

34. A method according to claim 32, wherein said step of processing (4) said received offer (230) further comprises the steps of:
valuating said received offer in accordance with input data (120) from said first bartering party;
valuating said received offer in accordance with input data (220) from said second bartering party;
presenting said valuations to said first bartering party.

35. A method according to claim 32, wherein said step of processing (4) a received offer (230) further comprises the steps of:
receiving data representing an item or items rejected from an offer (130) created by said programmable device (100);
computing a replacing offer based on said data representing said rejected item or items, said first and second sets of preference data (120, 220) and said items (110) available to said first party for bartering at said first programmable device; and
presenting said replacing offer to said second bartering party.

36. A method according to claim 32, wherein said step of processing (4) a received offer (230) comprises the steps of:
presenting said received offer for said first bartering party,
allowing said first bartering party to create a replacing offer, by altering said received offer; and
presenting said replacing offer to said second bartering party.

37. A method according to claim 36, further comprising the steps of:
valuating said replacing offer in accordance with input data from said first bartering party (120);
valuating said replacing offer in accordance with input data from said second bartering party (220); and
presenting said valuations to said first bartering party.

38. A method according to claim 37, further comprising the steps of:
computing a recommended alteration of said offer based on said received offer (230) and said computed (130) offer and said rejected items;
presenting said recommended alteration to said first bartering party.

39. A method according to claim 32, wherein said step of presenting an offer to said second bartering party comprises the steps of:
presenting a first offer (130) to said second bartering party, which offer contains one item;
receiving an accept (260) or rejection of said first offer from said second bartering party (200); and
presenting another offer to said to said second bartering party (200), which offer contains one item.

40. A method according to claim 32, further comprising the step of accessing items in accordance with Digital Rights Management regulations at said first device (100).

41. A programmable device (100) for automatic bartering for items, between at least a first and a second bartering party, comprising:
asset data representing items that are accessible to said first bartering party;
bartering data (110) representing items that are available for bartering to said first party;
means arranged to obtain and store a first set of preference data (120), that values items in accordance with input data originating from said first bartering party;
means arranged to receive and store a second set of preference data (220), that values items in accordance with input data originating from said second bartering party;
means arranged to compute a first offer (130) based at least on said first and second sets of preference data and said bartering data;
means arranged to send said first offer to said second bartering party;
means arranged to receive and store a second offer (230) related to said second bartering party;
means arranged to process said received offer;
means arranged to send an offer accept to said second bartering party;
means arranged to receive an offer accept originating from said second bartering party,
wherein said means arranged to process said received offer (230) is further arranged to compare offered items, contained in said received offer, to at least said asset data, said offer (130) computed by said first device (100) or data originating from said first bartering party, stating which items that are to be rejected, to reject one or several of said offered items and to receive a replacing offer (250) related to said second bartering party.

42. A device according to claim 41, further comprising:
means arranged to automatically value an unranked item or group of items based at least on said asset data and/or based on the value of previously valued items or group of items.

43. A device (100) according to claim 41, wherein said means arranged to process a received offer (130) is further arranged to value said received offer in accordance with input data from said first bartering party (120), to valuate said received offer in accordance with input data (220) from said second bartering party and to present said valuation to said first bartering party.

44. A device according to claim 41, wherein said means arranged to process said received offer is further arranged to receive data representing an item or items rejected from an offer (230) created by said device to compute a replacing offer (250) based on said data representing said rejected item or items, said first and second sets of preference data (120, 220) and said bartering data (210), and to send said replacing offer to said second bartering party.

45. A device according to claim 41, wherein said means arranged to process a received offer (230) is further arranged to present said received offer for said first bartering party, to allow said first bartering party to create a replacing offer by altering said received offer and to present said replacing offer to said second bartering party.

46. A device according to claim 45, wherein said means arranged to process a received offer is further arranged to value said replacing (250) offer in accordance with input data from said first bartering party (120), to value said replacing offer in accordance with input data from said second bartering party (220) and to present said valuations to said first bartering party.

47. A device according to claim 46, wherein said means arranged to process a received offer (130) is further arranged to compute an recommended alteration of said offer based on said received offer and said computed offer (230) and said rejected items.

48. A device according to claim 41, wherein said means for sending said offer (130) to said second bartering party is arranged to send an offer, containing one item, to said second bartering party, to receive an accept (160) or rejection of said first offer from said second bartering party, and to send a second offer, containing one item, to said second bartering party.

49. A device according to claim 41, further comprising means arranged to access items (110), accessible to said first bartering party, in accordance with Digital Rights Management regulations.

50. A device according to claim 41, wherein said device is connected to a wireless network.

51. A device according to claim 41, further comprising means arranged to send, receive and store said bartering items.

52. A system for automatic bartering for items, between at least a first and a second bartering party, comprising:
a first bartering device (100) arranged in accordance with claim 41; and
a second bartering device (200) arranged to send a second set of preference data (220) and an offer (230) to said first device, to receive a first set of preference data (120), an offer (130) and an offer accept (160) from said first device and to send an offer accept (260) to said first bartering device.

53. A system according to claim 52, wherein said second device (200) is arranged in accordance to a programmable device (100) for automatic bartering for items, between at least a first and a second bartering party, comprising:
asset data representing items that are accessible to said first bartering party;
bartering data (110) representing items that are available for bartering to said first party;
means arranged to obtain and store a first set of preference data (120), that values items in accordance with input data originating from said first bartering party;
means arranged to receive and store a second set of preference data (220), that values items in accordance with input data originating from said second bartering party;
means arranged to compute a first offer (130) based at least on said first and second sets of preference data and said bartering data;
means arranged to send said first offer to said second bartering party;
means arranged to receive and store a second offer (230) related to said second bartering party;
means arranged to process said received offer;
means arranged to send an offer accept to said second bartering party;
means arranged to receive an offer accept originating from said second bartering party,
wherein said means arranged to process said received offer (230) is further arranged to compare offered items, contained in said received offer, to at least said asset data, said offer (130) computed by said first device (100) or data originating from said first bartering party, stating which items that are to be rejected, to reject one or several of said offered items and to receive a replacing offer (250) related to said second bartering party.

54. A system according to claim 52, wherein said first and second bartering devices (100, 200) are both arranged on the same physical unit.

55. A system according to claim 52, further comprising:
first storage means storing items accessible (110) to said first bartering party; and
second storage means storing items accessible (110) to said second bartering party.

56. A system according to claim 55, wherein said first storage means is arranged on said first device.

57. A system according to claim 52, wherein said second bartering device (200) is further arranged to present an offer (130), received from said first bartering device (100), to said second bartering party.

58. A system according to claim 52, wherein said second bartering device (200) is further arranged to receive a rejection (140) from said first bartering device (100), of an offer (230) sent from said second bartering party, and to send a replacing offer (250) to said first bartering device.

59. A system according to claim 52, wherein said second bartering device (200) is further arranged to receive a replacing offer from said first bartering device (100).

60. A system according to claim 52, wherein said first and said second device (100, 200) are connected to a wireless network.
